(19) United States
(12) Patent Application Publication
(10) Pub. No.: US 2004/0200217 A1
(43) Pub. Date: Oct. 14, 2004

(54) Bladed heat transfer stator elements for a stirling rotary engine

(76) Inventor: George A. Marchetti, Western Springs, IL (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/409,471

(22) Filed: Apr. 8, 2003

(51) Int. Cl. F02G 1/04; F01B 29/10

(52) U.S. Cl. 60/517; 60/519

(57) ABSTRACT

The present invention includes a rotary engine, comprising a stator that includes a bladed heat transfer stator segment comprising an outer surface comprising a plurality of blades creating a flowpath on the outer surface. Rotary engines include Stirling engines and Wankel engines and compound rotary engines.

### BACKGROUND

The present invention relates to heat transfer stator elements for s Stirling rotary engine and to methods for making and assembling the elements.

Reverend Robert Stirling was motivated by the frequent fatal injuries associated with the steam power technologies of the 19th century to invent an engine that was inherently safe, but otherwise shared many of the operating characteristics of a typical steam engine. The result of Stirling's work was the “hot air engine”, which is known today as the “Stirling engine.” Like a steam engine, the Stirling engine is an external combustion engine that delivers the heat of combustion to a “working fluid”. The working fluid is alternately heated and cooled in the engine. A typical Stirling engine has two pistons with interconnected chambers and a regenerator. As the working fluid is heated in one chamber, e.g. by external combustion of a fuel, the pressure of the working fluid increases, thereby moving the piston. The moving piston turns a shaft and delivers power to the load. This is the first power stroke of the engine. The working fluid is then vented to the interconnection, through the regenerator and is cooled in the second chamber. The cooling of the working fluid creates a partial vacuum in the second chamber, thereby moving the second piston. The movement of the second piston also serves to turn the shaft and delivers additional power to the load. This is the second power stroke of the engine. The cycle is repeated as the working fluid passes back through the interconnection and the regenerator to the heating chamber. In effect, the Stirling engine is a simplified engine whose operation can be analogized to that of a steam engine. Instead of a boiler, however, the Stirling engine's heating chamber, and the working fluid in it, are heated directly. Instead of a condenser, the Stirling engine's cooling chamber, and the working fluid in it, are cooled directly, typically by means of water cooling. By eliminating both the boiler and condenser and by utilizing only a small amount of working fluid that is alternately heated and cooled, the Stirling's engine eliminated virtually all of the hazards associated with steam technology.

Rotary engines, such as the Wankel engine, have the potential to operate as Stirling engines in a two power stoke mode, i.e., an expansion power stoke and a partial vacuum power stroke. While the Wankel engine is used herein for illustrative purposes, it is understood that the tern “rotary engine” means any rotary engine having a stator. In general, a Wankel engine is essentially comprised of a triangular rotor with three curved faces, a stator with four zones (two compression zones and two expansion zones), face plates and a shaft. Working fluid can be heated in one of the compression zones. The heated working fluid then expands in the adjacent expansion zone and “pushes” the tip of the rotor. The working fluid is then cooled in the second compression zone. When the cooled working fluid is released into the second expansion zone, a partial vacuum is created which “pulls” the tip of the rotor in the direction of rotor rotation. In the case of a Wankel engine, with its triangular rotor, there are six power strokes per rotor revolution: three expansion power strokes and three partial vacuum power strokes.

Although few, if any, Stirling rotary engines have ever been built, the theory of the design is not unknown. There are several obvious advantages associated with Stirling rotary engines. Like all Stirling engines, Stirling rotary engines utilize external combustion. Consequently, virtually any combustible fuel can be employed by the engine, including natural gas, biogas, hydrogen, propane, and so forth. Fuel flexibility is a key characteristic of Stirling engines.

Stirling engines also tend to be relatively mechanically efficient because the partial vacuum power stroke supplements the expansion power stroke and provides additional power to the shaft. In addition, the capital costs associated with a Stirling rotary engine are minimized because there are few parts to the engine and because there is neither a separate boiler nor condenser, as in the steam engine case.

From a fuel efficiency standpoint, Stirling engines suffer from one defect which they share in common with all other external combustion engines. Because a portion of the heat of fuel combustion is ultimately released through a flue to atmosphere, a certain percentage of overall heat energy theoretically available in the fuel/air charge for heating the working fluid is lost and does not produce useful work (“flue waste heat”).

### DESCRIPTION OF THE DRAWINGS

FIG. 1A illustrates one embodiment of a top plan view of a blading pattern of a stator segment of the present invention.

FIG. 1B illustrates another embodiment of a top plan view of a blading pattern of the stator segment of the present invention.

FIG. 2, illustrates a cross-sectional view of one embodiment of a Stirling rotary engine that includes the stator segment of the present invention.

FIG. 3 illustrates a cross-sectional view of a compound Stirling rotary engine utilizing the bladed heat transfer stator segments of the present invention.

FIG. 4 illustrates a cross-sectional view of another compound engine embodiment, in which a secondary engine also serves as the radiator.

FIG. 5 illustrates a cross-sectional view of one other compound Stirling rotary engine that includes the stator segment of the present invention.

### SUMMARY

One embodiment of the present invention includes a rotary engine, comprising a stator that includes a bladed heat transfer stator segment comprising an outer surface comprising a plurality of blades creating a flowpath on the outer surface. Rotary engines include Stirling engines and Wankel engines.

Another embodiment of the present invention includes a method for making a rotary engine, comprising: making stator segment connectors in one or more molds; and placing the stator segment connectors in a second mold for molding stator segments, wherein the second mold produces a stator.

### DETAILED DESCRIPTION

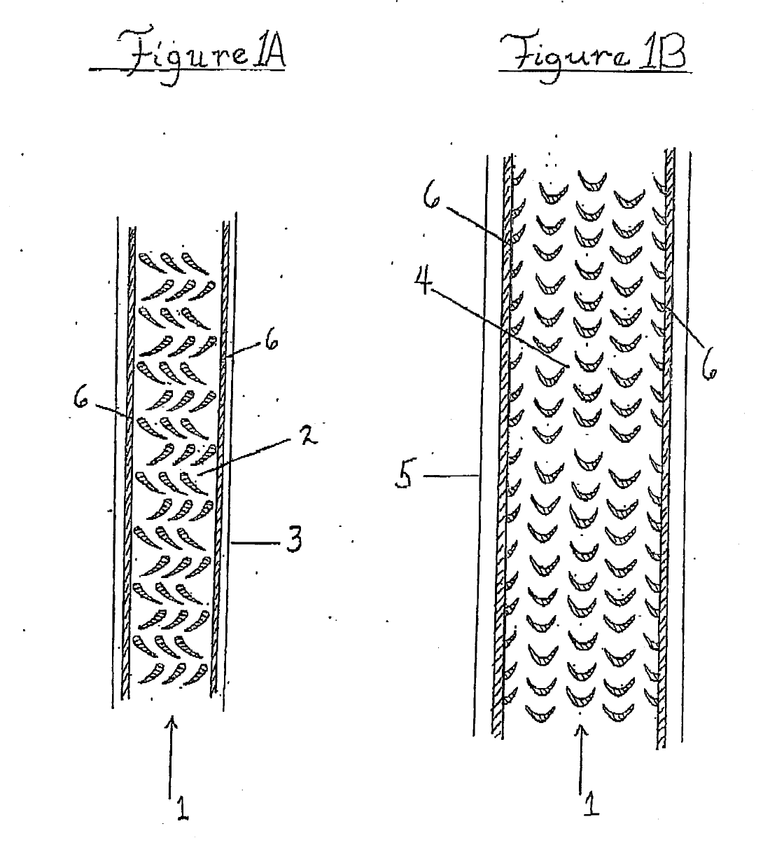

One purpose of the present invention is to capture some of the flue waste heat, employ it to heat the working fluid and thereby increase the overall fuel efficiency of a Stirling rotary engine. The present invention comprising a bladed heat transfer stator segment comprising blading on an outer surface of the stator segment and blading in the stator segment, accomplishes this purpose in two ways. First, blading on the outer surface of the stator segment increases the stator surface area, which allows more heat to be absorbed by the working fluid (in the case of the hot compression zone stator) or heat to be more quickly desorbed from the working fluid (in the case of the cold compression zone stator) than would otherwise occur with a smooth stator. Second the blading in the stator segment forces the combusted gas to flow in a generally serpentine path through the blading, thereby slowing the exit velocity of the combusted gas, reducing the temperature of the flue waste heat and permitting a portion of the flue heat to be absorbed by the stator segment and stator segment blading. The term “blading” as used herein, refers to a plurality of fins or protrusions, two of which are shown at 2 and 4 in FIGS. 1A and 1B respectively, on a segment of the stator.

In one embodiment, the stator segment blading is similar to impulse or reaction blading typically found in steam turbines. Unlike the steam turbine, however, where there are alternate fixed blades and moveable blades, the stator segment blading of the present invention is entirely fixed. Another purpose of the present invention, when used as the cold compression zone stator, is to more quickly deliver heat from the working fluid to the coolant prior to the partial vacuum power stroke and thereby better the engine's mechanical efficiency.

The present invention may best be understood with reference to the attached drawings. FIGS. 1A and 1B illustrate the blading of the stator segment. The blading forms many possible patterns and two of those patterns are illustrated in FIGS. 1A and 1B. Hot combusted gas 1 enters the flow field formed by the blades 2,4 of the stator segment 3,5. The blades 2 are molded, cast, machined or otherwise fabricated on the outer surface of the stator segment 3, 5.

The hot combusted gas 1 strikes against the surface of the blades 2,4, which serves to reduce the velocity of the hot combusted gas 1. The velocity of the gas is further reduced by the serpentine flow channels formed by the blades, two of which are shown at 2 and 4. As the velocity of the hot combusted gas 1 is reduced, sensible heat from the gas is absorbed by the blades 2,4 and by the stator segment 3,5. In turn, the heat from the stator segment is transferred to the working fluid in the Stirling rotary engine, as discussed below.

Also shown in FIGS. 1A and 1B are chamber gaskets 6. The chamber gaskets 6 seal the chamber (in this case the heating zone chamber) against the outer surface of the stator segment 3,5. The chamber gaskets 6 may be made of any high temperature gasket material such as flexible graphite or other materials known to those skilled in the art. The blading 2,4 illustrated in FIGS. 1A and 1B may also be utilized to transfer heat to coolant in the Stirling rotary engine. In one embodiment, the blading shown in FIG. 1A is used for the cooling zone. In that case, heat from the working fluid is absorbed by the stator segment 3 and the blading 2,4 and is then delivered to the coolant as it passes through the serpentine channels of the flow-field.

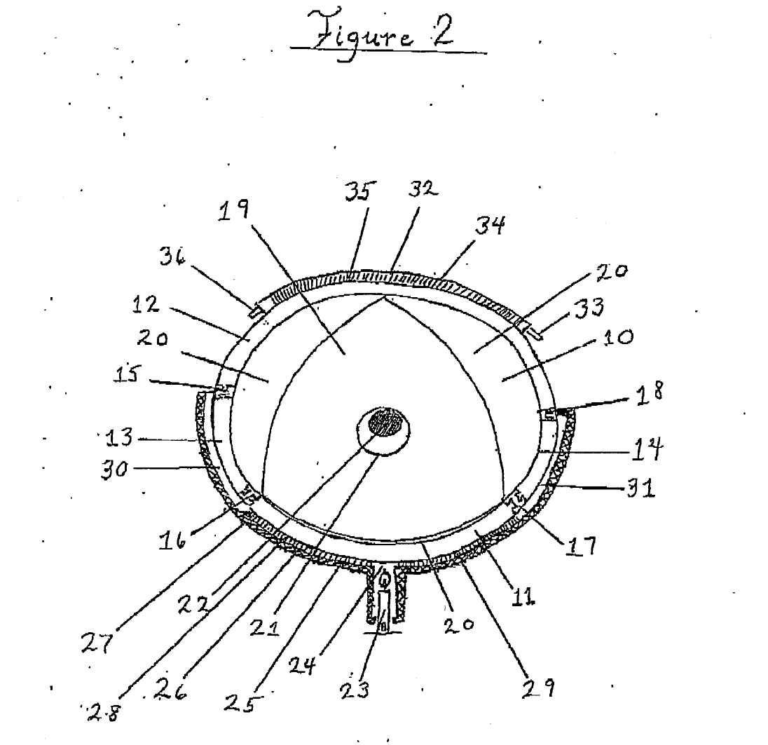

In FIG. 2, the present invention is shown as a component of a Stirling rotary engine. For illustrative purposes only, a Wankel engine 10 is selected as one possible rotary engine which could beneficially employ the invention. In FIG. 2 there are four stator segments: a heating zone stator segment 11, a cooling zone stator segment 12, and two expansion zone stator segments 13,14. The stator segments 11,12,13,14 are preferably comprised of a rigid, thermally conductive material, such as aluminum or other metals or metal alloys. The stator segments 11,12,13,14 are joined together by stator segment connectors 15,16,17,18. The stator segment connectors are preferably comprised of a thermally insulating material, such as Pyrex or other rigid, high-temperature insulating material. A rotor 19 is also shown in FIG. 2 The rotor 19 is preferably comprised of a thermally insulating material, such as Pyrex or other rigid, high-temperature insulating material that is capable of withstanding thermal shock as the rotor is alternately heated and cooled by the working fluid 20 as that fluid is compressed against the inner surface of the heating zone stator segment 11 and the cooling zone stator segment 12. The working fluid 20 may be a liquid (such as water) or may be a gas (such as hydrogen or helium). The rotor 19 has a gear 21 which meshes with a shaft 22. As the rotor 19 and the shaft 22 turn, power is delivered to the load, such as an electrical generator. Although not shown in FIG. 2 the engine also includes two face plates (preferably of insulated material) and associated gaskets which will seal the rotor 19 and the working fluid 20 in the engine.

A heat source 23 ignites a combustible fuel with an oxidant, such as air, to generate hot combusted gases. To avoid heat loss, combustion may occur in an insulated chamber 24 (the “heating zone chamber”). In addition, if an open flame is not desirable for the intended application (e.g., an automobile engine), then internal combustion of the fuel/air charge may occur separately in a free piston chamber, or other device, and the hot exhaust from the exhaust port may be delivered by means of a connecting tube to the heating zone chamber 24. The heating zone chamber 24 is comprised of an inner wall 25, an intermediate layer of high-temperature insulation 26 and an outer wall 27. A gasket 6 (FIGS. 1A and 1B) is interposed between the flanges of the inner wall 25 and the outer surface of the heating zone stator segment 11. The outer wall 27 may be joined by flanges to the face plate edges. The inner surface of the inner wall 25 presses against the blades 28,29 of the heating zone stator segment”. The hot combusted gases from the heat source 23 expand through flow-field formed by the blades 26,27, the outer surface of the heating zone stator segment 11 and the inner wall 25 of the heating zone chamber 24 and a portion of the sensible heat of the hot combusted gases is absorbed by the blades 25,29 and the heating zone stator segment 11. This heat is then delivered to the working fluid 20 at the inner surface of the heating zone stator segment' 11. As the hot combusted gases exit the flow-field, the gases enter a flue 30,31 (whose stator segment 13,1 may or may not be bladed) formed by an extension of the heating zone chamber 24. The expansion zone stator segments absorb some portion of the flue heat. The hot combusted gases (now substantially cooler) are vented from the flues 30,31 to atmosphere.

The bladed heat transfer stator of the present invention can also be beneficially employed to cool the working fluid 20. A coolant, which may be a liquid such as water or an alcohol for example, is pumped or otherwise delivered to the cooling zone chamber 32 at the coolant entry port 33. The cooling zone chamber 32 may have a single wall 34 in this embodiment. A gasket 6 (see, FIGS. 1A and 1B) is interposed between the flanges of the wall 34 and the outer surface of the cooling zone stator segment 12. The inner surface of the chamber wall 34 presses against the blades 35 of the cooling zone stator segment 12. The coolant flows from the coolant entry port 33 through the flow-field formed by the chamber wall 34 of the cooling zone chamber 32, the blades 35 and the outer surface of the cooling zone stator segment 12. Heat from the working fluid 20 is absorbed by the coolant from blades 3 and the cooling zone stator segment 12 The heated coolant is then released from the cooling zone chamber 32 at the coolant exit port 36. The coolant may thereupon be further cooled, if desired, in a heat exchanger, a radiator or by other devices known to those skilled in the art.

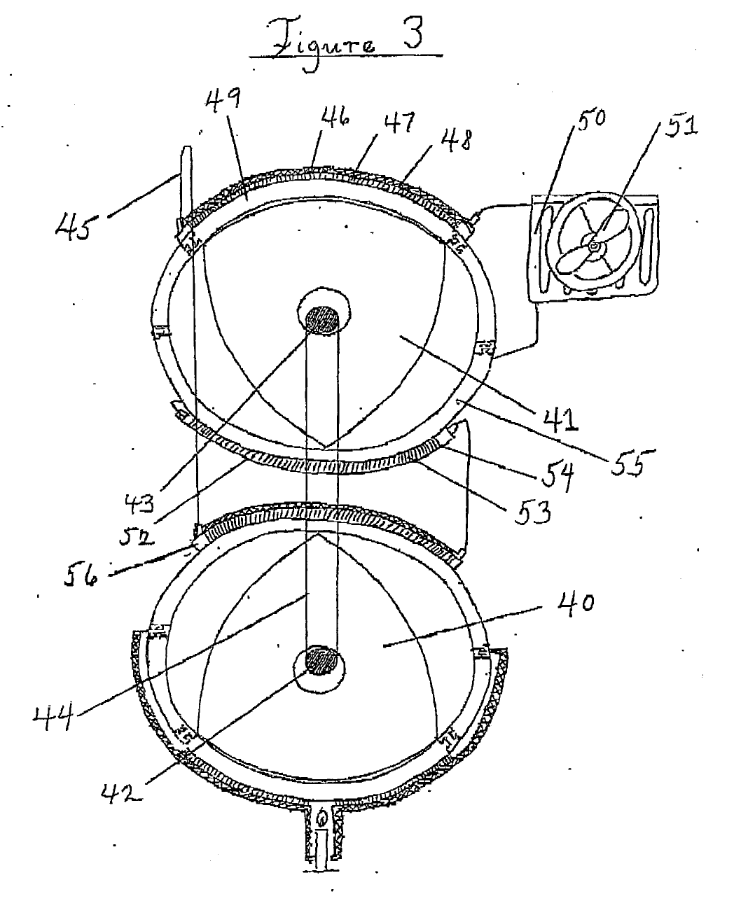

FIG. 3 illustrates a compound Stirling rotary engine utilizing the bladed heat transfer stator segments of the present invention. Except as otherwise specified below, the primary engine 40 is the engine previously described with respect to FIG. 2. The secondary engine 41 scavenges heat from the coolant to provide additional power to the shaft 42. The shafts 42,43 of the two engines 40,41 may be linked by a chain or belt 44 or may share a common shaft. The coolant is heated in the cooling zone chamber 56 of the primary engine 40, as previously discussed with respect to FIG. 2. However, if a low boiling point fluid is used as the coolant, such as methanol (boiling point 65 C.), then the cooling zone chamber 56 of the primary engine 4 may be insulated, as shown in FIG. 3, to retain coolant heat for the operation of the secondary engine 41. In that case, the cooling zone chamber 50 of the primary engine 40, the U-tube 45 and the heating chamber 46 of the secondary engine 4 may be comprised of a high-temperature plastic or other insulated material. The heated coolant will boil in the U-tube 45 and heat from the boiling coolant will be delivered through the tube to the secondary engine's heating chamber 46. The second engine's heating chamber 46 is insulated, like the cooling zone chamber 56 of the primary engine 40, and is otherwise similar to the cooling zone chamber 56. The heated coolant flows through the flow-field formed by the blades 47, the inner wall 48 of the second engine's heating chamber 46 and the outer surface of heating chamber stator segment 49 and a portion of the coolant's heat is transferred to the working fluid in the secondary engine 41. Because the U tube 45 acts as a pump, the coolant then may transit through a radiator where it may be further cooled by a fan 51. Neither the radiator nor the fan are intended to be to scale. The coolant, which is now at or near ambient temperature, is then pumped through the cooling zone chambers 52 of the secondary engine 41 which is constructed in a similar manner to the cooling zone chamber of the primary engine 40 except that it is not insulated. The coolant is heated somewhat in the cooling zone chamber 52 of the secondary engine 41 as it passes through the flow-field formed by the blades 53, the walls 54 of the cooling zone chamber 52 and the outer surface of the cooling zone stator segment 55 and then flows into the cooling zone chamber of the primary engine 40 to be heated to the boiling point. The secondary engine 41 provides additional power to the shafts 42,43 as the working fluid in the secondary engine is alternately heated and cooled.

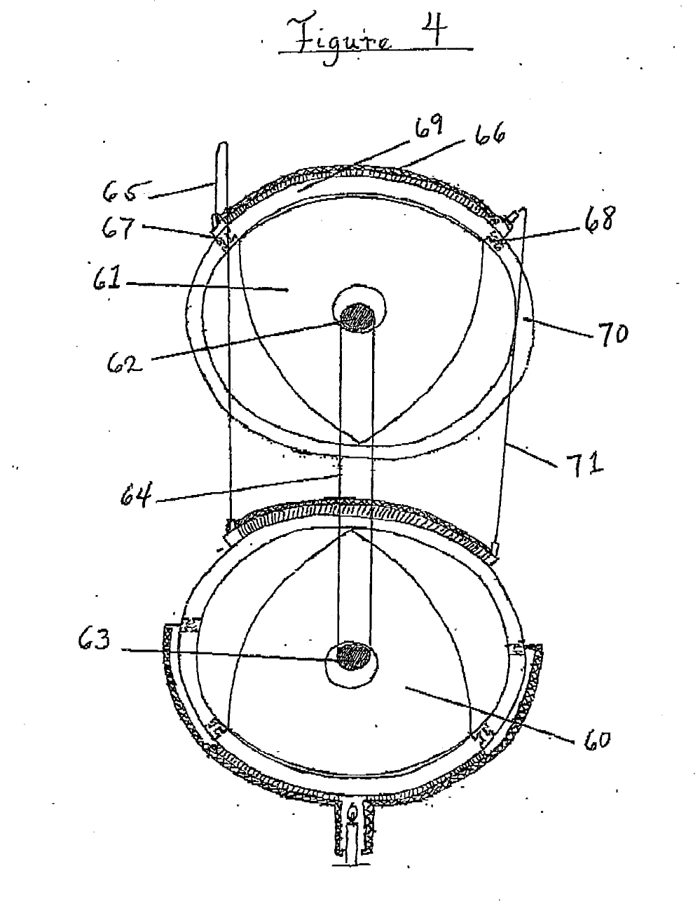

FIG. 4 illustrates another compound engine embodiment, in which the secondary engine also serves as the radiator—As in FIG. 3, there is a primary engine 60 and a secondary engine 61, which scavenges heat from the coolant to provide additional power to the shaft 62. The shafts 62,63 may be linked by a chain or be or may share a common shaft. Coolant is heated in the cooling zone chamber of the primary engine 60, as previously discussed with respect to FIG. 3. If a low boiling point fluid is used as the coolant, such as methanol (boiling point 65 C.), the heated coolant will boil in the U-tube 65 and heat from the boiling coolant will be delivered through the tube to the secondary engine's heating chamber 66. In this embodiment, as in FIG. 3, the heating chamber 66 is an insulated material, as is the cooling chamber of the primary engine 60 and the U-tube 65. However, there are only two thermally insulating stator segment connectors 67,68 rather than four and there is no cooling chamber in the secondary engine 61. This embodiment permits the heated coolant to be cooled in two ways. First, working fluid serves to cool the heated coolant as the working fluid traverses the inner surface of the bladed heat transfer stator segment 69 at the top of the secondary engine 61. Second, the working fluid, after absorbing heat from the heated coolant, is cooled to at or near ambient temperature by stator segment 70 and also by the face plates, which, in this embodiment, are comprised of a thermally conductive material such as a metal. The coolant, whose temperature now approaches ambient temperature, then flows through drain tube 71 into the cooling chamber of the primary engine 60. A fan may also be included if desired. In this embodiment, the secondary engine not only provides some additional power to the shaft, but also serves as the coolant radiator.

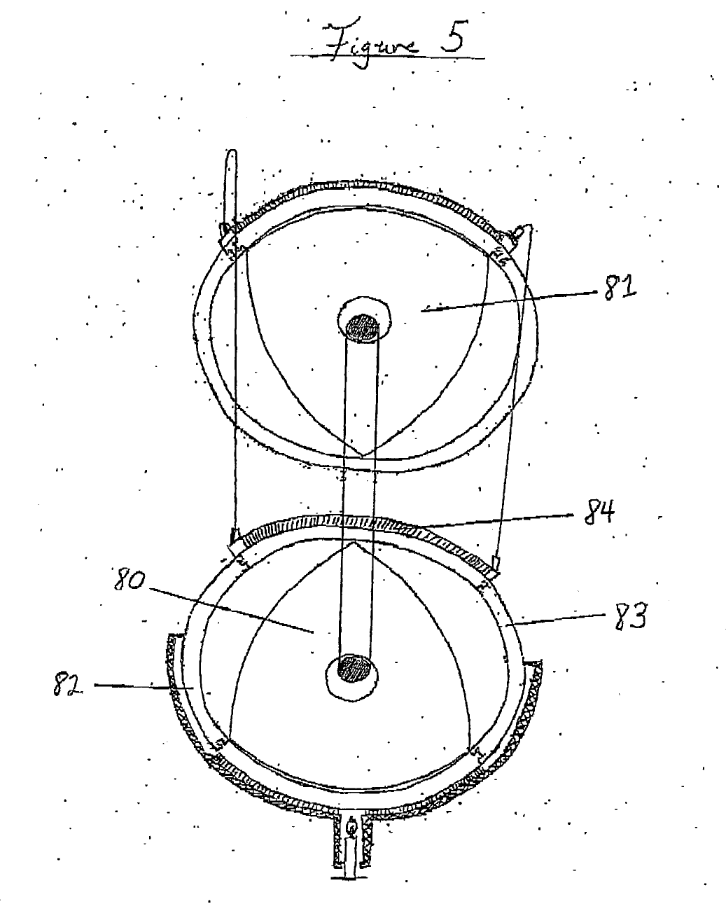

FIG. 5 illustrates a compound Stirling rotary engine, comprised of a primary engine 80 and a secondary engine 81 where the insulated connectors 82 and 83 have been extended to comprise expansion zone stators. This configuration may permit more heat from the primary engine 80 to be transferred from the working fluid in the primary engine 80 to the coolant in the primary engine's coolant chamber and then to the secondary engine 81.

In addition to the compound engines, discussed above, it should be noted that the bladed heat transfer stator segments allow the secondary engine to scavenge “waste heat” from other sources, such as internal combustion engine (with or without a waterjacket) for example.

A Stirling rotary engine with bladed heat transfer stator segments may result in significantly reduced manufacturing and the fuel costs for several reasons. First, the number of separate engine parts to be manufactured is relatively small. Second, the majority of the component parts can be cast or molded. The stator segment connectors can be molded. When the finished stator segment connectors are placed into a second mold, the stator segments (including the bladed stator segments of the present invention) can be cast in the same mold to produce a completed stator. The face plates and the rotor can also be separately molded. The gaskets, the heating zone chamber walls and the cooling zone chamber wall can be stamped, or in some embodiments molded, or otherwise fabricated from readily available materials. Thus, the manufacturing process can be accomplished with a relatively small number of steps, which should result in reduced engine production costs. Third, operating costs can be reduced since the present invention increases fuel efficiency by capturing a portion of the “flue waste heat”, utilizing that heat to produce additional power from the engine. Fourth, when the present invention is included in a compound engine, a portion of the primary engine's “waste heat” from its cooling zone chamber can (in addition to the “flue waste heat”) be utilized to generate additional power.

It is believed that the rotary engine of the present invention is capable of efficiently providing heat and electricity to dwellings ranging from homes to apartment buildings and office buildings. The flues of the rotary engine are connectable to a forced air or other gas heating box. The present invention is also capable of providing heat and electricity to villages, towns, and cities.

Thus, since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes, which come within the meaning and range of equivalency of the claims, are intended to be embraced therein.

What is claimed is:

1. A rotary engine, comprising a stator that includes a bladed heat transfer stator segment comprising an outer surface comprising a plurality of blades creating a flowpath on the outer surface.

2. The rotary engine of claim 1 wherein the blades are molded, cast or machined on the outer surface.

3. The rotary engine of claim 1, defining one or more heating zone chamber and cooling zone chamber, further comprising one or more gaskets for sealing each of the chambers against the bladed heat transfer stator segment.

4. The rotary engine of claim 1 wherein the engine is a Stirling engine.

5. The rotary engine of claim 1 wherein the engine is a Wankel engine.

6. The rotary engine of claim 1 wherein the stator segments are joined together by stator segment connectors.

7. The rotary engine of claim 6 wherein the stator segment connectors comprise a thermally insulating material.

8. The rotary engine of claim 3, further comprising a rotor radially separated from the stator segments.

9. The rotary engine of claim 8, further comprising working fluid within the flowpath.

10. A method for providing heat and electricity to a dwelling, comprising:
Installing the rotary engine, further comprising flues for exit of gases, of claim 9 from a dwelling; and
Connecting flues from the rotary engine to a forced air or heating box in the dwelling.

11. A method for making a rotary engine, comprising:
Making stator segment connectors in one or more molds; and
Placing the stator segment connectors in a second mold for molding stator segments, wherein the second mold produces a stator.

12. The method of claim 11, further comprising molding one or more of face plates and rotor.

13. The method of claim 11, further comprising stamping or molding one or more of gaskets, heating zone chamber walls and cooling zone chamber walls.

14. The device of claim 1 wherein the rotary engine is a compound rotary engine.
